(19) United States
(12) Patent Application Publication
(10) Pub. No.: US 2008/0154548 A1
(43) Pub. Date: Jun. 26, 2008

(54) Beltless Detector Systems for Combat Vehicles

(75) Inventors: C.G. (Gil) Young, Winter Park, FL (US); Jan J. Ksel, Casselberry, FL (US)

Correspondence Address: WELSH & KATZ, LTD, 120 S RIVERSIDE PLAZA, 22ND FLOOR, CHICAGO, IL, 60606, US

(73) Assignee: Lockheed Martin Corporation

(21) Appl. No.: 11/958,507

(22) Filed: Dec. 18, 2007

Related U.S. Application Data
(60) Provisional application No. 60/871,257, filed on Dec. 21, 2006.

(51) Int. Cl. G06F 11/30; G01J 1/00

(52) U.S. Cl. 702/188; 250/336.1; 250/338.1

(57) ABSTRACT

A beltless system for attaching MILES, laser signal-type, sensors to sides of combat vehicles during combat simulations includes at least one mounting magnet attached to each MILES sensor for a vehicle. The sensors can be mounted on respective sides of the vehicle in an arcuate pattern. A common receiver can be in communication with all sensors on a given side of the vehicle via an invisible wireless communication link.

### CROSS-REFERENCE TO RELATED APPLICATION

This application claims the benefit of the filing date of U.S. Provisional Application Ser. No. 60/871,257 filed Dec. 21, 2006, entitled “Systems and Methods for Eliminating CVS Belts” and incorporated herein by reference.

### FIELD

The invention pertains to combat simulation systems. More particularly, the invention pertains to such systems where sensor supporting belts on the sides of combat vehicles have been eliminated.

### BACKGROUND

Laser based combat simulation systems have been developed over a period of time to provide real-time tactical engagement simulations of direct fire force-on-force training. One such system, Multiple Integrated Laser Engagement System (MILES) and an updated version, MILES 2000, have been used by US military forces for training. MILES systems include vehicle mounted detectors of MILES standard 905 nm laser light beams indicative of hits by incoming munitions, such as bullets, or shells.

MILES detectors mounted on combat vehicle systems (CVSs) are currently arranged in linear arrays of up to eight detectors, every 20.5 inches, on cloth belts held to the vehicle by Velcro-brand types of attachments. They are wired to a processor centrally located on the belt. The processor output is hard-wired to the RF transmitter located high on the vehicle. It would be desirable to eliminate such belts because they tend to come off the vehicle during maneuvers due to encounters with brush, or other causes. In addition, the time to install the Velcro-type attachments and mount the belts is considered excessive, and de-mounting the vehicle-side of the Velcro pair is not always easy.

It will be understood that combat vehicles or combat vehicle systems include, without limitation, tanks, self propelled artillery, personnel carriers, and the like, all without limitation. The types of vehicle with which embodiments of the present invention can be used are not limitations of the invention.

Known detectors are usually spaced at 20.5-inch intervals so that a 1.1-mrad main gun laser transmitter (MGLT) beam cannot pass between two adjacent detectors without scoring a hit. The range for a 1.1-mrad beam to reach 20.5 inches in width is 472 meters. Closer than this, where the beam is narrower, there is probably enough near-field radiation so that the detectors will score a hit even if the 1.1-mrad beam is between two detectors.

Another reason for the relatively narrow beam width of 1.1 mrad is that if the beam is too wide it can be centered well away from the periphery of the vehicle and still score a hit from detectors near the vehicle periphery. This would provide negative training.

It appears that fielded MGLTs from various manufacturers, for use in MILES-type systems, have similar beam characteristics because their CVS systems also have detectors with similar spacing. Therefore the prospects of being able to change this spacing are dim due to the requirement of downward compatibility of all MILES equipment. Hence, in addressing the problem stated above, detectors must continue to be spaced at about 20.5-inch intervals, which means multiple detectors per vehicle side.

### BRIEF DESCRIPTION OF THE DRAWINGS

FIGS. 1A, 1B illustrate front and side views of detector modules in accordance with the invention;

FIG. 2 illustrates a plurality of the detector modules of FIG. 1A mounted on a representative vehicle;

FIG. 3 illustrates a spatial configuration of modules as in FIG. 2;

FIG. 4 is a block diagram of a detector as in FIG. 1; and

FIG. 5 is a block diagram of a central receiver as in FIGS. 2, 3.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention provide low-cost structures and methods of implementing stand-alone or autonomous detectors. Interconnecting wiring can also be eliminated thereby along with problems associated with the use of known types of attachment belts.

The Velcro-brand type attachment of belts can be eliminated by having each detector individually attached to the vehicle by a magnet, and incorporating the detectors' outputs into the system by other means than the current direct-wire communications. This configuration eliminates the belts.

For those vehicles that have non-magnetic sides, of aluminum or stainless steel, a steel pad, perhaps about 6 inches square, could be affixed to the vehicle, perhaps by use of Velcro-brand types of fasteners, so that the magnetic attachment can be made to the plate. With this embodiment, the need to have two types, or varieties of the detector modules can be avoided.

Appropriate magnet assemblies are commercially available in a form which includes an easy release, so that the magnetically-attached detectors can readily be demounted at the conclusion of the training cycle. For example, the Newport model MB-2 magnetic base is a cube about 2 inches on a side, and has a magnetic holding force of 90 pounds on an unpainted steel surface, slightly less on the typical combat-vehicle painted surface.

Putting an RF transmitter powerful enough to duplicate the performance of the current centralized CVS transmitter at the location of each detector would probably be prohibitively expensive. The antenna size and vulnerability to damage by brush or other hazards, too, would probably make this approach unacceptable.

In accordance with disclosed embodiments the individual detectors can be wirelessly linked to one central receiver per belt or vehicle side by means of optical or RF links. The belt-or-side central receiver would either transmit directly, or link to a known type of central transmitter high on the vehicle as is now done. Advantageously, in accordance herewith, the detector belts could be eliminated.

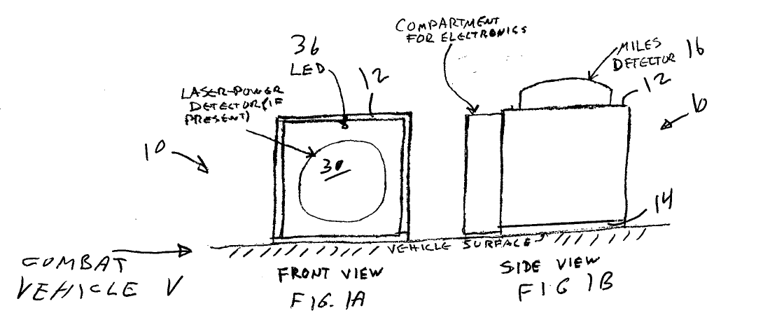

The electronics for the optical link would take the received MILES signals from the detector, amplify them without processing the information, and drive a 940 nm LED with the output, in a manner much like that of a TV remote control unit. FIGS. 1A, 1B illustrate an exemplary form of a detector module 10.

FIGS. 1A, 1B illustrate respectively a front view and a side view of a detector 10 in accordance with the invention. Detector 10 is of a type which is intended to be removably fixed to a combat vehicle V or any other type of vehicle, which is participating in a MILES-type simulation. Detector 10 includes an exterior housing 12 which could be formed of a selected plastic-type material or metal. Housing 12 which defines an interior region carries on a portion of its exterior peripheral surface a magnet 14. Magnet 14 is used to removably affix the detector 10 to the associated combat vehicle V.

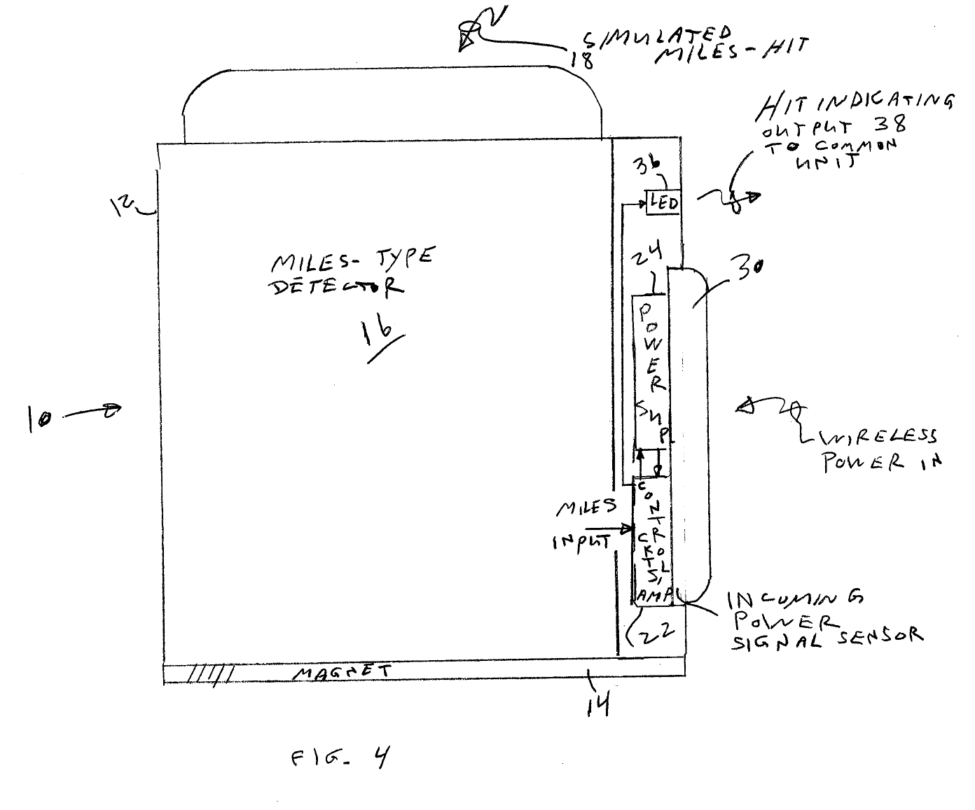

Detector 10 carries a MILES-type detector unit 16 of a known type which could be used to sense incoming laser light 18, as in FIG. 4, indicative of a simulated impact or hit relative to the combat vehicle V. Those of skill in the art will be familiar with the MILES-type simulation systems and no further discussion of such systems is necessary herein.

The detector 10 also carries control circuitry 22 which could include one or more amplifiers, a power supply 24, and an optional second sensor of incoming laser light 30 which, if present, can be coupled to the power supply 24 to provide an input source for radiant energy coupled thereto to provide a source of electrical energy for the detector 10. Alternately, or in addition to, the power supply 24 can include one or more rechargeable batteries.

Detector 10 also carries at least one output source of radiant energy which could be either a light emitting diode, such as LED 36, or an RF transmitter.

Incoming hit indicating 905 nm light signals 18, which could carry coded information as to source and the like, are re-transmitted via circuits 22 and emitter 36 to a common or central receiver 40. In MILES-type systems, the incoming signals carry pre-defined MILES coding which is re-transmitted to the common unit 40. Optionally, the control circuits, and amplifiers, 22 could add information to indicate which detector, or module, received the hit. Such information would be useful as part of a training exercise to determine where the combat vehicle was hit. Other variations come within the spirit and scope of the present invention.

An LED wavelength of 940 nm can be used. LEDs at this wavelength are commonly available, and this wavelength is invisible with night vision goggles (NVGs). Standard MILES silicon detectors, for example detector 16 of module 10, are sensitive at this wavelength. The LEDs could transmit to a standard MILES detector at the common receiver 40 at the center of the quasi-linear array of detectors, discussed in more detail subsequently. This centrally-located detector, at receiver 40, could include a cut-off optical filter that blocks out wavelengths shorter than 940 nm and therefore also the direct MILES 905 nm light. Hence, direct MILES radiation from side angles would not be detected. If this radiation were detected it would subvert the intent of identifying the direction from which the incident MILES radiation comes. Signal processing and transmission would then follow known paths as would be understood by those of skill in the art.

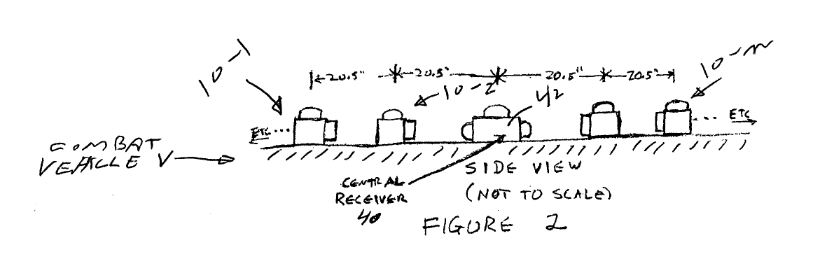

FIG. 2 depicts an exemplary layout of multiple detector modules 10i wirelessly linked to the central receiver 40 in accordance with one embodiment of the invention. FIG. 2 illustrates a plurality of detectors 10-1,- 2 . . . -n comparable to detector 10 of FIGS. 1A, 1B and 4. The plurality of modules, or, detectors 10-1 . . . 10-n are all magnetically attached to a combat vehicle, such as the combat vehicle V noted above relative to detector 10. Those units 10-i are wirelessly coupled to a common or central receiver 40.

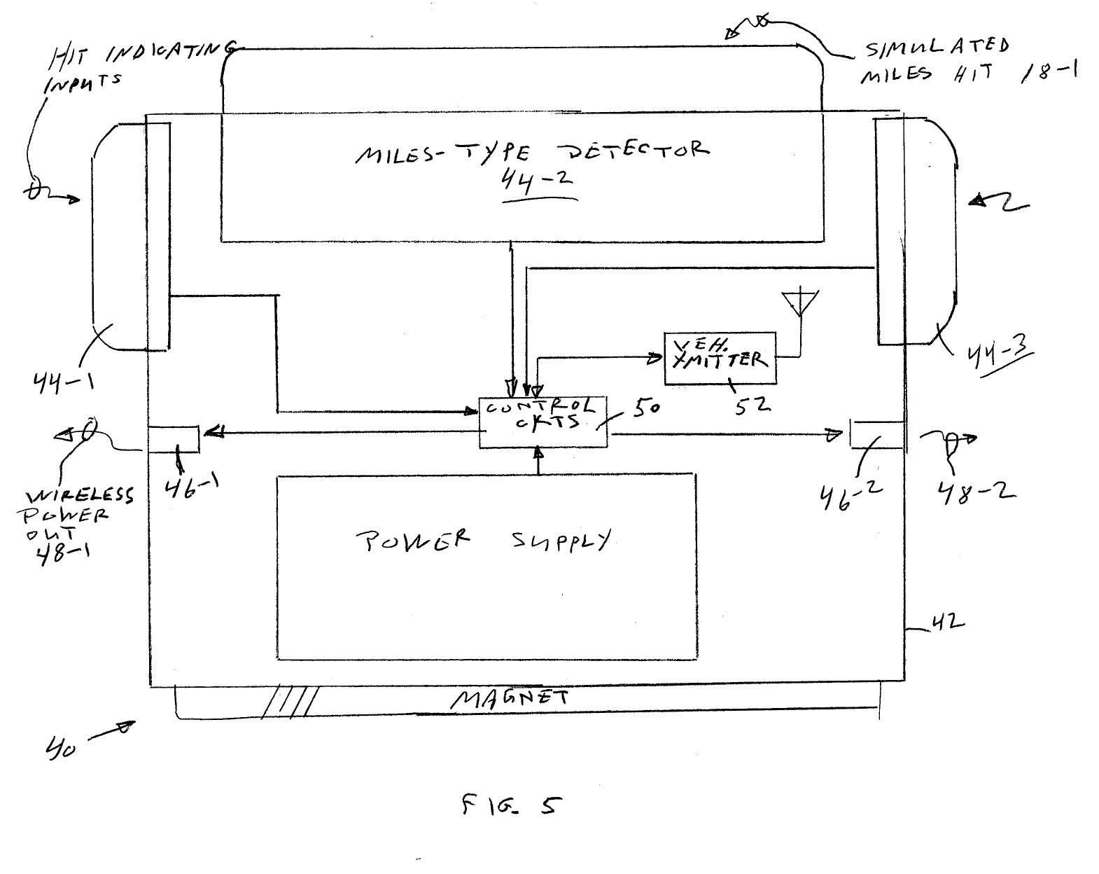

Receiver 40, illustrated in more detail in FIG. 5, includes a housing 42 which can carry a plurality of spaced apart MILES-type detectors 44-1, -2 and -3. Detector 44-2 corresponds in function to the detector 16 of the modules 10-i. Those detectors are intended to respond to incoming laser light corresponding to simulated hits or impacts on the vehicle V. Detectors 44-1, 44-3 can be modified to incorporate a cut-off optical filter which blocks out wavelengths shorter than 940 nanometers, as noted above, so as to not respond to incoming MILES-type radiation of 905 nanometers. The central receiver or common receiver 40 is in bi-directional communication with the detectors 10-i via the detectors 44-1, 44-3 as well as lasers or light-emitting diodes 46-1, -2.

Sensors 44-1, 44-3 receive wireless outputs from the detectors 10-i indicative of simulated MILES-type hits 18. All such inputs are coupled to control circuitry 50 in the common unit 40. Hence, information pertaining to incoming hits sensed by the detectors 10-i, is wirelessly coupled to the receiver 40. The receiver 40 also emits radiant energy via outputs 46-1, -2 for purposes of energizing power supply 24 where the wireless power option is present. The unit 40 also includes a vehicular transmitter 52 which is in communication with the simulation electronics, not shown, on the associated vehicle V. Incoming information sensed via detectors 44-1, -2 and -3 is in turn wirelessly communicated to the vehicular electronics.

If an RF link to the central receiver 40 were used instead of the LED link transmission might take place by means of a surface RF wave on the surface of the vehicle, or by using small, inductively- or capacitively-loaded antennas. The exact details of implementing such transmissions are not limitations of the invention.

Power to operate the individual detectors 10-i could also be supplied by a rechargeable or one-time-use battery. An alternative would be to use a very large capacitance capacitor, or ultra-capacitor, functioning as a battery. The battery/capacitor could be kept charged by using a moving-magnet/coil combination much used in watches and battery-less flashlights, or a piezoelectric element/weight combination. The natural vibration and movement of the vehicle, even in idle mode, could be enough to keep the battery/capacitor charged.

The solar, DC component of MILES detector output, which is currently not used, could also be used to charge the battery or ultra-capacitor.

As discussed above, another way of keeping the battery/capacitor charged would be to have a laser diode transmitter at the central receiver 40 send a beam to the detector 30 on the side of the MILES-detector module 10-i. In this embodiment, the electrical energy from a detector of this laser light would be used to recharge the battery/capacitor. Energy to drive the central laser transmitter could be derived from the vehicle's power supply.

In accordance with embodiments of the invention, alignment of the LED with the central receiver 40 is not critical, as long as an unobstructed, direct line-of-sight path is available, and the detector module 10-i is aligned to be reasonably normal to this path, within the angle of radiation of the LED. The individual detector modules 10-i would be slightly displaced from a straight-line array into a quasi-linear array to allow the various LED and laser beams to have access.

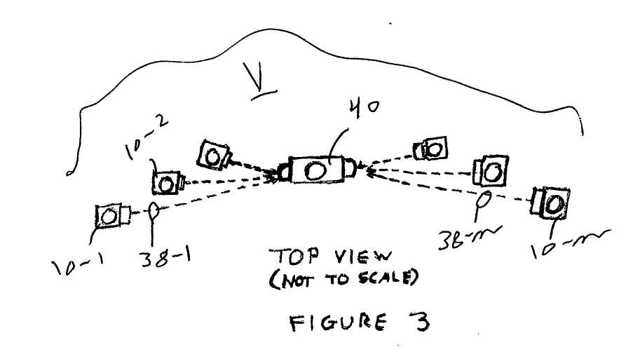

FIG. 3 illustrates how the individual detector modules 10-i can be arrayed in a quasi-linear configuration, on the side of the combat vehicle V, to enable the LED radiation 38-i from each one to have an un-obscured path to the central receiver 40.

FIG. 3 illustrates the detectors 10-i which are in wireless communication via links 38-i with the common or central unit 40. As noted above, the units 10-i would be slightly displaced from a straight line array into a quasi linear array to provide access to the various emitted beams such as 38i as well as received power beams 48-1, -2 where that option is present. As illustrated in FIG. 3 the common unit 40 as well as the detectors 10-i are all magnetically mounted on a side portion of the vehicle V as would be appropriate for implementing the simulation.

As an installation, alignment and functionality aid a simple 940 nm LED source, running at a few-kHz pulse repetition frequency (PRF) (where the ear is most sensitive), could be temporarily placed on the module's detector. The central receiver 40 could include an amplitude modulation (AM) detector circuit as part of its detection circuitry, and a headphone jack, so the installer can hear the few-kHz tone when the detector module 10-i is aligned. The louder the tone, the better the alignment. This would also verify the alignment and functionality of the LED link.

There should be no eye-safety concerns with the level of LED power required here, just as there are none for TV remote control units. If commercially-available 980 nm laser diodes are used for the power-transmission operation between the central receiver location and the individual detector assemblies, the Class 1 eye hazard threshold is 3.63 milliwatts/cm², 3.63 times the value for a visible laser. This should be adequate to keep the individual battery/capacitors charged, because it could be running continuously, while the incoming MILES signals would be occurring sporadically.

Just as for the 940 nm LED, the 980 nm laser light would be invisible to NVGs. The MILES detectors would not see the 980 nm radiation because it would be perpendicular to a normal to the detectors. In addition, because it is continuous wave (cw) any stray 980 nm light that should enter the MILES detector would be rejected by the detection circuitry. This circuitry accepts only AC components, and rejects DC components such as sunlight.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A device that senses incident radiant energy comprising:
a housing having an exterior peripheral surface;
a magnet carried by the housing adjacent to a portion of the exterior surface;
a sensor of incident radiant energy, the sensor, responsive to incident radiant energy, at least some of which is substantially parallel to a first axis generally perpendicular to a second portion of the exterior surface; and
an emitter of first radiant energy carried by the housing, the emitter is oriented to transmit the radiant energy on a second axis perpendicular to the first axis.

2. A device as in claim 1 which includes circuitry coupled between the sensor and emitter, and responsive to sensed incident radiant energy, the circuitry activates the emitter to transmit an indicium thereof

3. A device as in claim 2 where the emitter comprises one of a light emitting element, or, a radio frequency emitting element.

4. A device as in claim 3 where the sensor responds to incoming incident radiation with a wavelength on the order of 905 nm.

5. A device as in claim 3 where the light emitting element emits a beam of radiant energy with a wavelength on the order of 940 nm.

6. A device as in claim 3 where the circuitry includes at least one amplifier in a transmission path between the sensor and emitter.

7. A device as in claim 3 which includes a second sensor, oriented to receive incident radiant energy along the second axis.

8. A device as in claim 3 which includes a rechargeable power supply.

9. A device as in claim 7 which includes a rechargeable power supply.

10. A device as in claim 9 where energy received via the second sensor is coupled to the rechargeable power supply.

11. A system comprising:
a plurality of detectors, each detector comprising:
a housing having an exterior peripheral surface;
a magnet carried by the housing adjacent to a portion of the exterior surface;
a sensor of incident radiant energy, the sensor, responsive to incident radiant energy, at least some of which is substantially parallel to a first axis generally perpendicular to a second portion of the exterior surface;
an emitter of hit indicating radiant energy carried by the housing, the emitter is oriented to transmit the radiant energy on a second axis, perpendicular to the first axis; and
a common unit which receives the radiant energy and which retransmits an indication thereof.

12. A system as in claim 11 where the common unit includes a housing, the housing carrying a mounting magnet.

13. A system as in claim 11 where the common unit includes first and second, spaced apart, first radiant energy receivers oriented to receive incident radiant energy, some of the incident radiant energy travels substantially in a selected direction toward a respective receiver, and some of the incident radiant energy travels substantially opposite the selected direction toward a respective receiver.

14. A system as in claim 13 where at least one of the receivers includes a cut-off optical filter with a selected cut-off wavelength.

15. A system as in claim 13 which includes control circuits coupled to the receivers and to an indicator transmitter where the common unit includes first and second, spaced apart, incident radiant energy receivers oriented to receive incident radiant energy, some of the incident radiant energy travels substantially in a selected direction toward a respective receiver, and some of the incident radiant energy travels substantially opposite the selected direction toward a respective receiver.

16. A system as in claim 15 where the indicator transmitter comprises a radio frequency transmitter.

17. A system as in claim 15 where the common unit includes at least one directional radiant energy transmitter to couple operational electrical energy to respective detectors.

18. A method comprising:
establishing a plurality of hit locations on a combat vehicle;
magnetically locating a plurality of detectors at the respective locations on the vehicle with the detectors responding to incoming radiant energy beams representative of incoming hits;
wirelessly transmitting, in a selected direction, from some of the detectors indicia indicative of a sensed hit; and
collecting the indicia at a substantially common location and wirelessly re-transmitting a representation thereof to a displaced location.

19. A method as in claim 18 where transmitting from others of the detectors includes transmitting indicia indicative of an incoming hit opposite the selected direction.

20. A method as in claim 19 where collecting includes receiving the indicia at first and second receiving locations at the common locations.

21. A method as in claim 20 which includes establishing line of sight transmission paths between at least some of the detectors and the receiving locations.

22. A method as in claim 20 where transmitting includes transmitting beams of coherent light substantially along the selected direction; and
opposite the selected direction.

23. A method as in claim 22 where incoming radiant energy beams, representative of incoming hits, travel in a direction substantially orthogonal to the selected direction.

24. A method as in claim 20 which includes collecting the indicia at first and second, spaced apart, common locations.

25. A method as in claim 24 which includes establishing the first and second common locations on opposite sides of the vehicle.

26. A method as in claim 18 where wirelessly transmitting includes adding additional information indicative of hit location to the transmitted indicia.
